(19) United States
(12) Patent Application Publication
(10) Pub. No.: US 2024/0394698 A1
(43) Pub. Date: Nov. 28, 2024

(54) SYSTEMS AND METHODS FOR CODE-BASED CHECK AUTHENTICATION AND CLEARANCE

(71) Applicant: JPMORGAN CHASE BANK, N.A., New York, NY (US)

(72) Inventor: Gurpreet AHLUWALIA, Dehradun (IN)

(21) Appl. No.: 18/323,882

(22) Filed: May 25, 2023

(51) Int. Cl. G06Q 20/40; G06Q 20/04

(52) U.S. Cl. CPC G06Q 20/40; G06Q 20/042

(57) ABSTRACT

A method for code-based check authentication and clearance may include payer bank computer program executed by a payer bank backend: (1) receiving check details for a check written by a payer to a payee; (2) generating a check passcode; (3) associating the check passcode with the check details, wherein the check details comprise a check number and an amount; (4) receiving, from a payee bank backend, a received check passcode and received check details; (5) validating an association between the received check passcode and the received check details based on the association between the check passcode and the check details; (6) notifying the payee bank backend that the check is cleared in response to the validation; and (7) debiting, a payer account for an amount of the check.

### BACKGROUND OF THE INVENTION

### 1. Field of the Invention

Embodiments relate to systems and methods for code-based check authentication and clearance.

### 2. Description of the Related Art

Paying by check is a common way for a payer to pay a payee. For example, a check is issued by the payer in the payee name. The payee then deposits the check with the payee's bank. The payee bank sends the check to the payer bank and the payer bank will clear the check after verifying the authenticity of the check. The payee bank account is then credited with the amount. It can, however, take several days to clear a check if the payer bank and the payee bank are different. And checks can also be rejected by either bank during clearance for a variety of reasons. For example, if the payer did not sign the check using the same signature that is on record with the payer's bank, the check can be rejected.

Checks are also susceptible to fraud. For example, checks can be stolen, can be altered or tampered to change the amount, payee name, etc., checks can be counterfeit, checks can have forged signatures, etc. This leads to potential losses by the payer as well as the banks.

### SUMMARY OF THE INVENTION

Systems and methods code-based check authentication and clearance are disclosed. According to an embodiment, a method for code-based check authentication and clearance may include: (1) receiving, by a payer bank computer program executed by a payer bank backend, check details for a check written by a payer to a payee; (2) generating, by the payer bank computer program, a check passcode; (3) associating, by the payer bank computer program, the check passcode with the check details, wherein the check details comprise a check number and an amount; (4) receiving, by the payer bank computer program and from a payee bank backend, a received check passcode and received check details; (5) validating, by the payer bank computer program, an association between the received check passcode and the received check details based on the association between the check passcode and the check details; (6) notifying, by the payer bank computer program, the payee bank backend that the check is cleared in response to the validation; and (7) debiting, by the payer bank computer program, a payer account for an amount of the check.

In one embodiment, the check details may be received from a payer bank computer application executed by a payer electronic device.

In one embodiment, the payer bank computer application may include an online bill pay computer application.

In one embodiment, the check details may be received from a payer bank teller terminal.

In one embodiment, the check passcode may include an alphanumeric code, a machine-readable code, etc.

In one embodiment, the method may also include sending, by the payer bank computer program, the check passcode to a payee electronic device associated with the payee.

In one embodiment, the method may also include: receiving, by the payer bank computer program, a check clearing restriction; associating, by the payer bank computer program, the check clearing restriction with the check passcode; receiving, by the payer bank computer program, payer bank information; and determining, by the payer bank computer program, that the payer bank information meets the check clearing restriction. The check clearing restriction may restrict clearing to a payee account, to a specific payee bank, to a location, or to a check presentation method.

According to another embodiment, a method for code-based check authentication and clearance may include: (1) receiving, by a payee bank computer program executed by a payee bank backend, check details for a check written by a payer to a payee and a check passcode, wherein the check details comprise a check number and an amount; (2) communicating, by the payee bank computer program, the check details and the check passcode to a payer bank backend, wherein the payer bank backend is configured to validate an association between the check details and the check passcode; (3) receiving, by the payee bank computer program, notification that the check has cleared; and (4) crediting, by the payee bank computer program, a payee account for an amount of the check.

In one embodiment, the check details may be received from a payee bank computer application executed by a payee electronic device.

In one embodiment, the check details may be received from a payee bank kiosk or teller terminal.

In one embodiment, the check details may be extracted from an image of the check.

In one embodiment, the check passcode may be received as an alphanumeric code.

In one embodiment, the check passcode may be received as a machine-readable code.

In one embodiment, the method may also include sending, by the payee bank computer program, payee bank information to the payer bank, wherein the payer bank backend is configured to validate the payee bank information against a check clearing restriction. The check clearing restriction may restrict clearing to a payee account, to a specific payee bank, to a location, or to a check presentation method.

According to another embodiment, a non-transitory computer readable storage medium may include instructions stored thereon, which when read and executed by one or more computer processors, cause the one or more computer processors to perform steps comprising: (1) receiving check details for a check written by a payer, wherein the check details comprise a check number and an amount; (2) generating a check passcode; (3) associating the check passcode with the check details; (4) receiving a received check passcode and received check details from a payee bank backend; (5) validating an association between the received check passcode and the received check details based on the association between the check passcode and the check details; (6) notifying the payee bank backend that the check is cleared in response to the validation; and (7) debiting a payer account for an amount of the check.

In one embodiment, the check passcode may include an alphanumeric code or a machine-readable code.

In one embodiment, the non-transitory computer readable storage medium may also include instructions stored thereon, which when read and executed by one or more computer processors, cause the one or more computer processors to perform steps comprising receiving a check clearing restriction, wherein the check clearing restriction restricts clearing to a payee account, to a specific payee bank, to a location, or to a check presentation method; associating the check clearing restriction with the check passcode; receiving payer bank information; and determining that the payer bank information meets the check clearing restriction.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for code-based check authentication and clearance according to an embodiment;

FIGS. 2A and 2B illustrate a method for code-based check authentication and clearance according to an embodiment;

FIG. 3 depicts an exemplary computing system for implementing aspects of the present disclosure.

### DETAILED DESCRIPTION OF PREFERRED EMBODIMENTS

Embodiments relate to systems and methods for code-based check authentication and clearance.

In embodiments, a payer (e.g., a check issuer) may create a digital check passcode for a check using a bank computer program or application. For example, the payer may enter information about the check, such as the check number, date of issue, amount, payee name, etc. In one embodiment, the payer may capture an image of the check and this information may be automatically extracted from the image.

The payer may also enter one or more check clearing restrictions, such as payment to a specific payee account, payment at a specific bank, presentation within a certain location (e.g., city, state, etc.), check expiration, transferability, presentation method (e.g., in-person only), etc.

The bank computer program or application, or a backend thereof, may generate and store a check passcode. The check passcode may be an alphanumeric code, or it may be a machine-readable code. The bank computer program or application may provide the check passcode to the payer and the payer may provide it to the payee, or the bank computer program or application may provide the check passcode to the payee directly via, for example, email, text message, near field communication between a payer electronic device and a payee electronic device, etc.

When the payee goes to the payee bank to deposit or cash the check, the payee may present the check passcode to the payee bank teller, electronic device (e.g., automated teller machine), or may enter it into the a mobile application for the payee's bank. In one embodiment, the payee bank employee may enter the check details (e.g., check number, date, amount, payee name, etc.). In another embodiment, a payee bank computer program may extract the details from an image of the check. In still another embodiment, the payee may enter the check details into a payee bank computer program, a terminal, etc.

The payee bank may provide an image of the check, the check details, and the check passcode to the payer bank. The payee bank may also provide information the bank name, location, manner of presentation, etc.) to the payer bank.

The payer bank may retrieve the check details that are associated with the check passcode, and may compare the check details to the check details received by the payee bank. If they match, then the payer bank will clear the check for payment.

If the check passcode is invalid or if the digital code is valid but the check details do not match, the payer bank will not clear the check. The payee bank may follow standard procedures for clearing the check.

In embodiments, the payer bank may enforce any check clearing restrictions on the check that were entered by the payer. If any of the check clearing restrictions are not met, the payer bank will not clear the check.

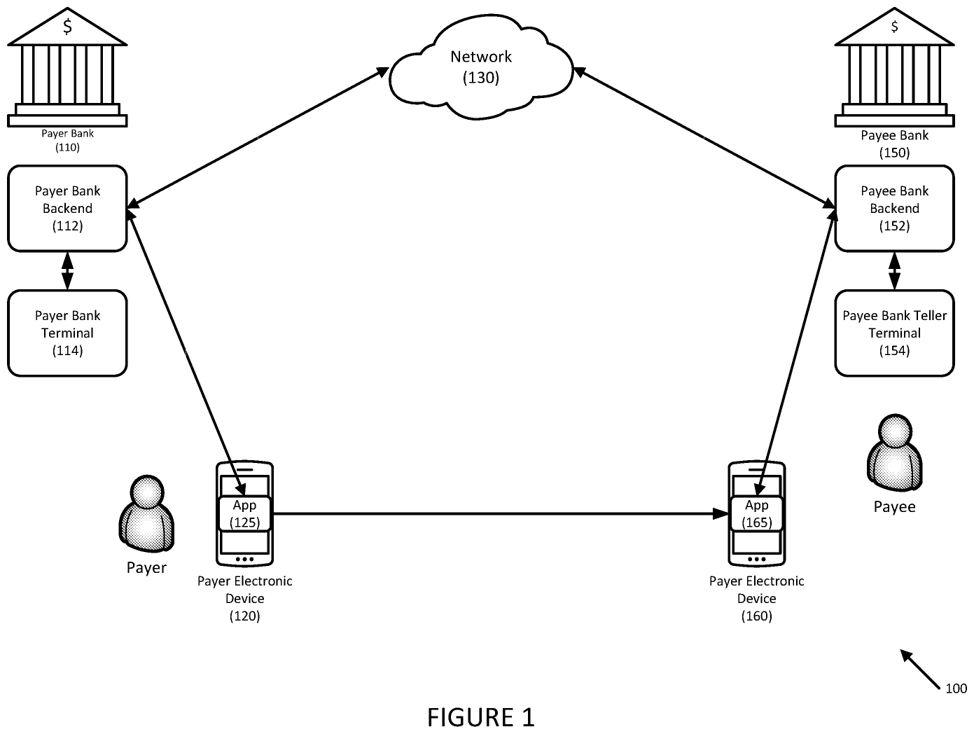

Referring to FIG. 1, a system for classifications is disclosed according to one embodiment. System 100 may include payer bank 110 and payee bank 150. In one embodiment, payer bank 110 and payee bank 150 may be different banks; in another embodiment, payer bank 110 and payee bank 150 may be the same bank.

Payer bank 110 and payee bank 150 may be associated with backends, such as payer bank backend 112 and payee bank backend 152, and terminals, such as payer bank terminal 114 and payee bank backend 152. Backends 112 and 152 may execute one or more computer programs that may present and/or clear checks. Backends 112 and 152 may communicate with each other via network 130, which may be any suitable network.

Terminals 114 and 154 may include teller terminals, automated teller machines, kiosks, etc. In one embodiment, the payer and/or payee may provide a check to its respective terminal 114, 154, where it may be imaged and check details may be extracted from the image. In another embodiment, the payer and/or payee may enter check details into its respective terminal 114, 154. In another embodiment, a bank employee (e.g., a teller) may enter check details into the respective terminal 114, 154.

The payer and the payee may be associated with payee electronic device 120 and payee electronic device 160, respectively. Electronic devices 120 and 160 may be computers (e.g., workstations, desktops, laptops, notebooks, tablets, etc.), smart devices (e.g., smart phones, smart watches, etc.), Internet of Things (IoT) appliances, etc. Electronic devices 120 and 160 may execute computer programs or applications (“apps”) 125 and 165 that may be associated with their respective banks 110 and 150.

Electronic devices 120 and 160 may communicate using Bluetooth, WiFi, Near Field Communication, by SMS message, by email, by voice, etc. In one embodiment, app 125 may present a check passcode in the form of a machine-readable code (e.g., a QR code) that may be imaged by app 165.

Apps 125 and 165 may receive an image of a check using, for example, a camera, and may extract check details from the image. In one embodiment, apps 125 and 165 may provide the image of the check to its respective backend 112 or 152, which may extract the check details, and may return the check details to app 125 or 165.

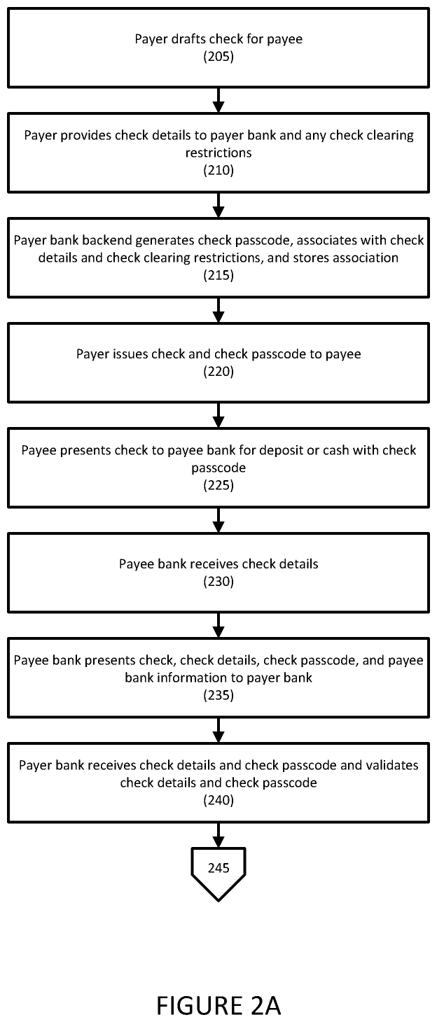

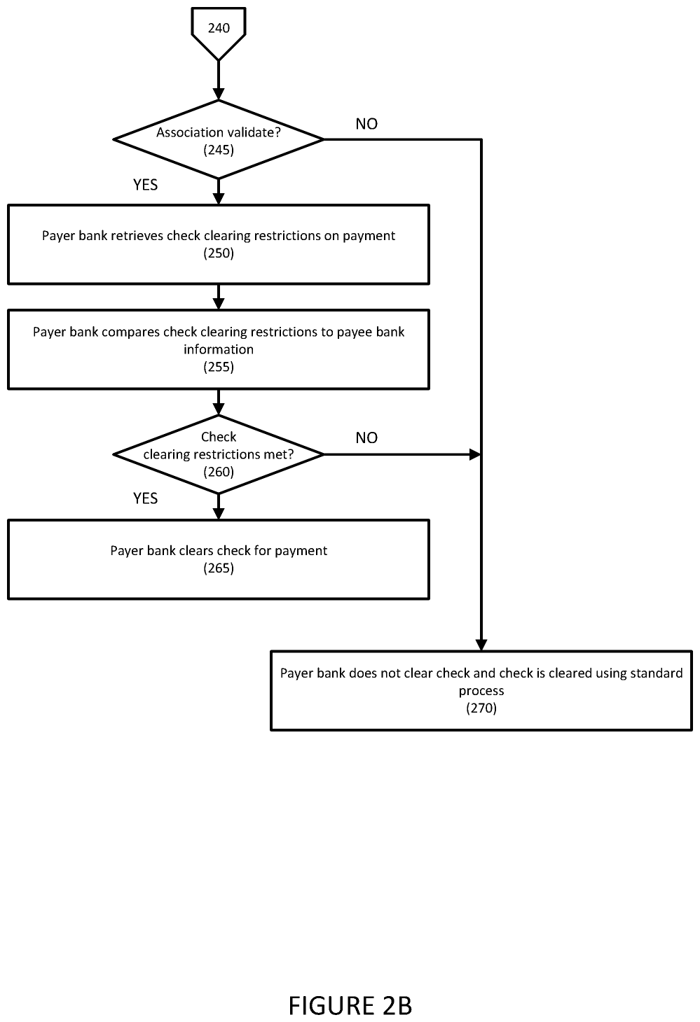

Referring to FIGS. 2A and 2B, a method for code-based check authentication and clearance is disclosed according to one embodiment.

In step 205, a payer may draft a check to pay a payee. In one embodiment, the payer may write a check on paper, may enter check details in an online banking computer program, may enter check details in a third party computer program, etc. The check details may include the check number, a check amount, a check issue date, and a payee name.

In step 210, the payer may provide the check details to the payer bank along with any check clearing restrictions associated with the check. In one embodiment, the payer may manually enter the details into a payer bank computer program or application, may scan an image of the check using a payer bank computer program, may enter the check details at a bank terminal (e.g., a kiosk, ATM, with a bank teller, etc.).

If desired, the check clearing restrictions may restrict the check to being deposited or cashed, may restrict the location at which the check may be deposited or cashed (e.g., a specific branch, a city, a state, etc.), may set an expiration on the payment period for the check (e.g., one day, one week, one month, etc.), may limit transferability, may restrict the deposit to a specific account, may include combinations thereof, etc.

In step 215, the payer bank, using a payer bank backend, may generate a check passcode, may associate the check passcode with the check details, and may store the association in a database. In one embodiment, the payer bank backend may also associate any check clearing restrictions with the check passcode and store those.

In one embodiment, the check passcode may be an alphanumeric code, such as a six digit and/or character code. In another embodiment, the check passcode may be a machine-readable code, such as a QR code.

In one embodiment, the check passcode need not be unique; a single check code may be associated with check details for multiple checks. The association between the check details and the check passcode is unique and the association may be used to validate the check details.

In step 220, the payer may issue the check and the check passcode to the payee. For example, the payer may hand the check to the payee and may verbally inform the payee of the code. As another example, the payer or payer's bank may mail the check to the payee and may call the payee with the check passcode. In another embodiment, the payer may hand or the payer or payer's bank may mail the check to the payee, and the payer's bank may send the check passcode to the payer via email, SMS, voice message, etc.

In one embodiment, the payer's app may communicate the code to the payee's app by presenting a machine readable code that is imaged by the payee's app, may communicate the code via near field communication or similar, etc.

In step 225, after receiving the check and the check passcode, the payee may present the check to the payee bank for deposit or cashing. The payee may also provide the check passcode.

In one embodiment, the payee may hand the check to a teller, and may tell the teller the check passcode, may enter it using a keypad, or may present a machine-readable code. In another embodiment, the payee may provide the check to a kiosk or ATM at the payee bank and may enter or present a machine-readable code to the kiosk or ATM. In another embodiment, the payee may scan an image of the check using a payee bank computer application and may enter or scan the machine-readable code.

In step 230, the payee bank may receive the check details. For example, the teller may manually enter the check number, check amount, date, payee, etc. into, for example, a payer bank portal.

In another embodiment, the payee bank backend or the payee bank app may extract the check details from an image of the check. In another embodiment, the payee may enter the details into a kiosk, ATM, or payee bank application.

In step 235, the payee bank presents the check (e.g., an image of the check), the check details, the check passcode, any payee bank information (e.g., bank name, bank location) and/or any payee actions with the check (e.g., cashing the check, depositing the check, the account to which it is being deposited, etc.).

For example, in one embodiment, the payee bank representative may present the check details and the check passcode, for example, to the payer bank portal. In another embodiment, the payee bank may receive the check details and check passcode from the payee from, for example, the payee bank application, an ATM, a web application, etc. and may then submit the check details and check passcode to the payer bank.

In step 240, the payer bank may receive the check details and check passcode and may validate the check details and check passcode. In one embodiment, the payer bank may validate that the check passcode and the check details received are associated with each other. For example, the payer bank may look up the association in a database.

In step 245, if the association between the check details and the check passcode is validated, in step 250, the payer bank may optionally retrieve the check clearing restrictions, if any, on the payment.

In step 255, the payer bank may compare the check clearing restrictions to payee bank information or payee actions. If, in step 260, the check clearing restrictions are met, in step 265, the payer bank may clear the check for payment. For example, as part of the clearing process, the payer bank may debit the payer account, and may notify the payer of the transaction. It may also inform the payee bank that the check has cleared so that the payee bank can credit the payee account for the amount and notify the payee of the payee of the transaction. The payer bank may then send the amount to the payee bank using standard procedures.

If the check details do not match, or if the check passcode is incorrect, or the check clearing restrictions are not met, in step 270, the payer bank will not clear the check. The check may then be cleared using standard procedures.

The payer bank may inform the payee that the check will be cleared using standard procedures and any holds may be applied as is necessary and/or desired.

In one embodiment, if the check passcode or check details do not match, the payee may be given additional opportunities to re-enter the check passcode or the check details before the payer bank does not clear the check.

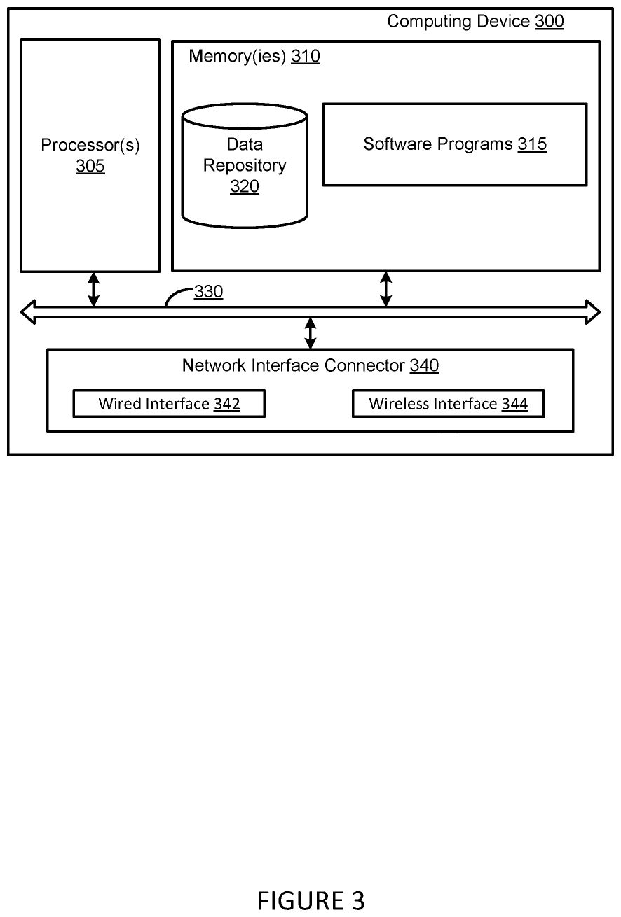

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method for code-based check authentication and clearance, comprising:
receiving, by a payer bank computer program executed by a payer bank backend, check details for a check written by a payer to a payee;
generating, by the payer bank computer program, a check passcode;
associating, by the payer bank computer program, the check passcode with the check details, wherein the check details comprise a check number and an amount;
receiving, by the payer bank computer program and from a payee bank backend, a received check passcode and received check details;
validating, by the payer bank computer program, an association between the received check passcode and the received check details based on the association between the check passcode and the check details;
notifying, by the payer bank computer program, the payee bank backend that the check is cleared in response to the validation; and
debiting, by the payer bank computer program, a payer account for an amount of the check.

2. The method of claim 1, wherein the check details are received from a payer bank computer application executed by a payer electronic device.

3. The method of claim 2, wherein the payer bank computer application comprises an online bill pay computer application.

4. The method of claim 2, wherein the check details are received from a payer bank teller terminal.

5. The method of claim 1, wherein the check passcode comprises an alphanumeric code.

6. The method of claim 1, wherein the check passcode comprises a machine-readable code.

7. The method of claim 1, further comprising:
sending, by the payer bank computer program, the check passcode to a payee electronic device associated with the payee.

8. The method of claim 1, further comprising:
receiving, by the payer bank computer program, a check clearing restriction;
associating, by the payer bank computer program, the check clearing restriction with the check passcode;
receiving, by the payer bank computer program, payer bank information; and
determining, by the payer bank computer program, that the payer bank information meets the check clearing restriction.

9. The method of claim 8, wherein the check clearing restriction restricts clearing to a payee account, to a specific payee bank, to a location, or to a check presentation method.

10. A method for code-based check authentication and clearance, comprising:
receiving, by a payee bank computer program executed by a payee bank backend, check details for a check written by a payer to a payee and a check passcode, wherein the check details comprise a check number and an amount;
communicating, by the payee bank computer program, the check details and the check passcode to a payer bank backend, wherein the payer bank backend is configured to validate an association between the check details and the check passcode;
receiving, by the payee bank computer program, notification that the check has cleared; and
crediting, by the payee bank computer program, a payee account for an amount of the check.

11. The method of claim 10, wherein the check details are received from a payee bank computer application executed by a payee electronic device.

12. The method of claim 10, wherein the check details are received from a payee bank kiosk or teller terminal.

13. The method of claim 10, wherein the check details are extracted from an image of the check.

14. The method of claim 10, wherein the check passcode is received as an alphanumeric code.

15. The method of claim 10, wherein the check passcode is received as a machine-readable code.

16. The method of claim 10, further comprising:
sending, by the payee bank computer program, payee bank information to the payer bank, wherein the payer bank backend is configured to validate the payee bank information against a check clearing restriction.

17. The method of claim 16, wherein the check clearing restriction restricts clearing to a payee account, to a specific payee bank, to a location, or to a check presentation method.

18. A non-transitory computer readable storage medium, including instructions stored thereon, which when read and executed by one or more computer processors, cause the one or more computer processors to perform steps comprising:
receiving check details for a check written by a payer, wherein the check details comprise a check number and an amount;
generating a check passcode;
associating the check passcode with the check details;
receiving a received check passcode and received check details from a payee bank backend;
validating an association between the received check passcode and the received check details based on the association between the check passcode and the check details;
notifying the payee bank backend that the check is cleared in response to the validation; and
debiting a payer account for an amount of the check.

19. The non-transitory computer readable storage medium of claim 18, wherein the check passcode comprises an alphanumeric code or a machine-readable code.

20. The non-transitory computer readable storage medium of claim 18, further including instructions stored thereon, which when read and executed by one or more computer processors, cause the one or more computer processors to perform steps comprising
receiving a check clearing restriction, wherein the check clearing restriction restricts clearing to a payee account, to a specific payee bank, to a location, or to a check presentation method;
associating the check clearing restriction with the check passcode;
receiving payer bank information; and
determining that the payer bank information meets the check clearing restriction.
